(19) United States
(12) Patent Application Publication
(10) Pub. No.: US 2012/0066668 A1
(43) Pub. Date: Mar. 15, 2012

(54) C/C++ LANGUAGE EXTENSIONS FOR GENERAL-PURPOSE GRAPHICS PROCESSING UNIT

(75) Inventors: Ian Buck, San Jose, CA (US); Bastiaan Aarts, San Jose, CA (US)

(73) Assignee: NVIDIA Corporation, Santa Clara, CA (US)

(21) Appl. No.: 13/180,494

(22) Filed: Jul. 11, 2011

Related U.S. Application Data
(63) Continuation of application No. 11/556,057, filed on Nov. 2, 2006, now abandoned.

(51) Int. Cl. G06F 9/45

(52) U.S. Cl. 717/149

(57) ABSTRACT

A general-purpose programming environment allows users to program a GPU as a general-purpose computation engine using familiar C/C++ programming constructs. Users may use declaration specifiers to identify which portions of a program are to be compiled for a CPU or a GPU. Specifically, functions, objects and variables may be specified for GPU binary compilation using declaration specifiers. A compiler separates the GPU binary code and the CPU binary code in a source file using the declaration specifiers. The location of objects and variables in different memory locations in the system may be identified using the declaration specifiers. CTA threading information is also provided for the GPU to support parallel processing.

### CROSS-REFERENCES TO RELATED APPLICATIONS

This application is a continuation of U.S. application Ser. No. 11/556,057, filed Nov. 2, 2006, which is incorporated by reference.

### BACKGROUND OF THE INVENTION

The present invention relates in general to data processing, and in particular to data processing methods using C/C++ language extensions for programming a general-purpose graphics processing unit.

Parallel processing techniques enhance throughput of a processor or multiprocessor system when multiple independent computations need to be performed. A computation can be divided into tasks, with each task being performed as a separate thread. (As used herein, a “thread” refers generally to an instance of execution of a particular program using particular input data.) Parallel threads are executed simultaneously using different processing engines, allowing more processing work to be completed in a given amount of time.

Numerous existing processor architectures support parallel processing. The earliest such architectures used multiple discrete processors networked together. More recently, multiple processing cores have been fabricated on a single chip. These cores are controlled in various ways. In some devices, known as multiple-instruction, multiple data (MIMD) machines, each core independently fetches and issues its own instructions to its own processing engine (or engines). In other devices, known as single-instruction, multiple-data (SIMD) machines, a core has a single instruction unit that issues the same instruction in parallel to multiple processing engines, which execute the instruction on different input operands. SIMD machines generally have advantages in chip area (since only one instruction unit is needed) and therefore cost; the downside is that parallelism is only available to the extent that multiple instances of the same instruction can be executed concurrently.

Graphics processors (GPUs) have used very wide SIMD architectures to achieve high throughput in image-rendering applications. Such applications generally entail executing the same programs (vertex shaders or pixel shaders) on large numbers of objects (vertices or primitives). Since each object is processed independently of all others using the same sequence of operations, a SIMD architecture provides considerable performance enhancement at reasonable cost. Typically, a GPU includes one SIMD core (e.g., 200 threads wide) that executes vertex shader programs, and another SIMD core of comparable size that executes pixel shader programs. In high-end GPUs, multiple sets of SIMD cores are sometimes provided to support an even higher degree of parallelism.

Parallel processing architectures often require that parallel threads be independent of each other, i.e., that no thread uses data generated by another thread executing in parallel or concurrently with it. In other cases, limited data-sharing capacity is available. For instance, some SIMD and MIMD machines provide a shared memory or global register file that is accessible to all of the processing engines. One engine can write data to a register that is subsequently read by another processing engine. Some parallel machines pass messages (including data) between processors using an interconnection network or shared memory. In other architectures (e.g., a systolic array), subsets of processing engines have shared registers, and two threads executing on engines with a shared register can share data by writing it to that register.

Traditionally, the programming environments for GPUs have been domain specific solutions targeted at generating images. Languages like Cg (developed by the NVIDIA Corporation of Santa Clara, Calif.) and HLSL (“High Level Shader Language” developed by the Microsoft Corporation of Redmond, Wash.) allow users to write vertex and pixel (fragment) shaders in an environment that is similar to the C/C++ programming environment. These solutions work well for graphics-specific applications (e.g., video games) but are not well-suited for general-purpose computation. While similar to C/C++, the Cg and HLSL languages do not formally adhere to the C/C++ standard in many fundamental areas (e.g., lack of pointer support). Since these languages target specific programmable portions of the graphics pipeline, they present a constrained programming model which targets the specified capabilities for that particular programmable stage of the pipeline. For example, pixel shaders are defined to only accept a single fragment from a rasterizer and write the result to a pre-determined location in the output frame buffer. These constraints, though appropriate for shader programming, make it difficult for programmers lacking specific graphics knowledge to use the GPU as a general-purpose computation engine.

It would therefore be desirable to provide a general-purpose programming environment which allows users to program a GPU using C/C++ programming constructs.

### BRIEF SUMMARY OF THE INVENTION

Embodiments of the present invention provide a general-purpose programming environment that allows users to program a GPU as a general-purpose computation engine using familiar C/C++ programming constructs. Users may use declaration specifiers to identify which portions of a program are to be compiled for a CPU or a GPU. Specifically, functions, objects and variables may be specified for GPU binary compilation using declaration specifiers. A compiler separates the GPU binary code and the CPU binary code using the declaration specifiers. The location of objects and variables in different memory locations in the system may be identified using the declaration specifiers. CTA threading information is also provided for the GPU to support parallel processing.

In accordance with an embodiment of the present invention, a method for compiling a source file is disclosed. The source file is loaded into a compiler. The source file includes code associated with execution of functions on a GPU and code associated with execution of functions on a CPU. GPU programming language is identified in the source file. The GPU programming language indicates that code associated with the GPU programming language is to be executed on the GPU. The code associated with the GPU programming language is separated from the source file. The code associated with the GPU programming language is converted into binary code for execution on a GPU.

In accordance with another embodiment of the present invention, a system for compiling a source file includes a global memory shared between a CPU and a GPU. A source file is stored in the global memory. The source file includes code associated with execution of functions on a GPU and code associated with execution of functions on a CPU. The CPU includes a compiler that loads the source file from the global memory. GPU programming language identifies portions of the source file as code to be executed on the GPU. The compiler separates the code identified by the GPU programming language from the source file. The code identified by the GPU programming language is converted into binary code for execution on a GPU. The GPU includes memory for storing the binary code. The GPU also includes at least one processing engine configured to execute the binary code.

The following detailed description together with the accompanying drawings will provide a better understanding of the nature and advantages of the present invention.

### BRIEF DESCRIPTION OF THE DRAWINGS

FIG. 1 is a block diagram of a computer system according to an embodiment of the present invention;

FIG. 2 is a block diagram of a graphics processing unit including a processing core usable in an embodiment of the present invention;

FIG. 3 is a block diagram of a GPU and a CPU usable in an embodiment of the present invention; and

FIG. 4 is a flowchart illustrating a process for compiling a source file that includes C/C++ language extensions for general-purpose GPU programming according to the present invention.

### DETAILED DESCRIPTION OF THE INVENTION

### System Overview

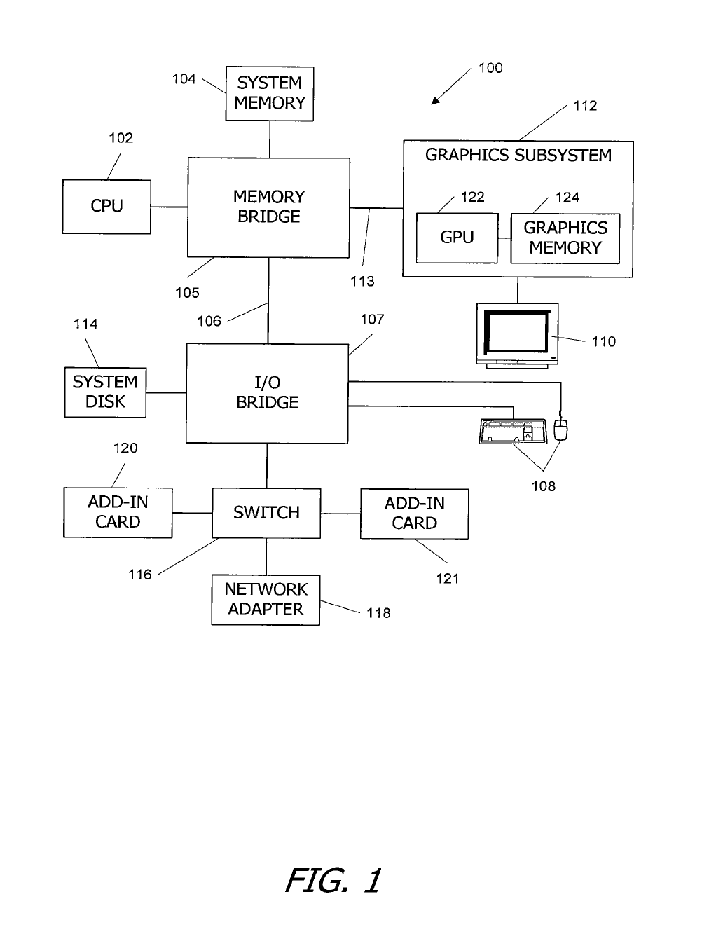

FIG. 1 is a block diagram of a computer system 100 according to an embodiment of the present invention. Computer system 100 includes a central processing unit (CPU) 102 and a system memory 104 communicating via a bus path that includes a memory bridge 105. Memory bridge 105 is connected via a bus path 106 to an I/O (input/output) bridge 107. I/O bridge 107 receives user input from one or more user input devices 108 (e.g., keyboard, mouse, etc.) and forwards the input to CPU 102 via bus 106 and memory bridge 105. A graphics subsystem 112 is coupled to I/O bridge 107 via a bus or other communication path 113 (e.g., a PCI Express or Accelerated Graphics Port link); in one embodiment graphics subsystem 112 delivers pixels to a display device 110 (e.g., a conventional CRT or LCD based monitor) A system disk 114 is also connected to I/O bridge 107. A switch 116 provides connections between I/O bridge 107 and other components such as a network adapter 118 and various add-in cards 120, 121. Other components (not explicitly shown), including USB or other port connections, CD drives, DVD drives, and the like, may also be connected to I/O bridge 107. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols as is known in the art.

Graphics subsystem 112 includes a graphics processing unit (GPU) 122 and a graphics memory 124, which may be implemented, e.g., using one or more integrated circuit devices such as programmable processors, application specific integrated circuits (ASICs), and memory devices. GPU 122 advantageously implements a highly parallel processor including one or more processing cores, each of which is capable of executing a large number (e.g., hundreds or thousands) of threads concurrently. GPU 122 can be programmed to perform a wide array of computations. GPU 122 may transfer data from system memory 104 and/or graphics memory 124 into internal memory, process the data, and write result data back to system memory 104 and/or graphics memory 124 where such data can be accessed by other system components including, e.g., CPU 102. In some embodiments, GPU 122 is a graphics processor that can also be configured to perform various tasks related to generating pixel data from graphics data supplied by CPU 102 and/or system memory 104 via memory bridge 105 and bus 113, interacting with graphics memory 124 (e.g., a conventional frame buffer) to store and update pixel data, delivering pixel data to display device 110, and the like. In some embodiments, graphics subsystem 112 may include one GPU 122 operating as a graphics processor and another GPU 122 used for general-purpose computations, and the GPUs may be identical or different, and each GPU may have its own dedicated memory device(s).

CPU 102 operates as the master processor of system 100, controlling and coordinating operations of other system components. In particular, CPU 102 issues commands that control the operation of GPU 122. In some embodiments, CPU 102 writes a stream of commands for GPU 122 to a command buffer, which may be in system memory 104, graphics memory 124, or another storage location accessible to both CPU 102 and GPU 122. GPU 122 reads the command stream from the command buffer and executes commands asynchronously with operation of CPU 102.

It will be appreciated that the system shown herein is illustrative and that variations and modifications are possible. The bus topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, graphics subsystem 112 is connected to I/O bridge 107 rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

The connection of GPU 122 to the rest of system 100 may also be varied. In some embodiments, graphics system 112 is implemented as an add-in card that can be inserted into an expansion slot of system 100. In other embodiments, a GPU is integrated on a single chip with a bus bridge, such as memory bridge 105 or I/O bridge 107.

A GPU may be provided with any amount of local graphics memory, including no local memory, and may use local memory and system memory in any combination. For instance, GPU 122 can be a graphics processor in a unified memory architecture (UMA) embodiment; in such embodiments, little or no dedicated graphics memory is provided, and the GPU 122 would use system memory 104 exclusively or almost exclusively. In UMA embodiments, GPU 122 may be integrated into a bus bridge chip or provided as a discrete chip with a high-speed link (e.g., PCI-E) connecting GPU 122 to the bridge chip and system memory 104.

It is also to be understood that any number of GPUs may be included in a system, e.g., by including multiple GPUs on a single add-in card or by connecting multiple add-in cards to path 113. Multiple GPUs may be operated in parallel to process data at higher throughput than is possible with a single GPU.

Systems incorporating GPUs may be implemented in a variety of configurations and form factors, including desktop, laptop, or handheld personal computers, servers, workstations, and so on.

### Core Architecture

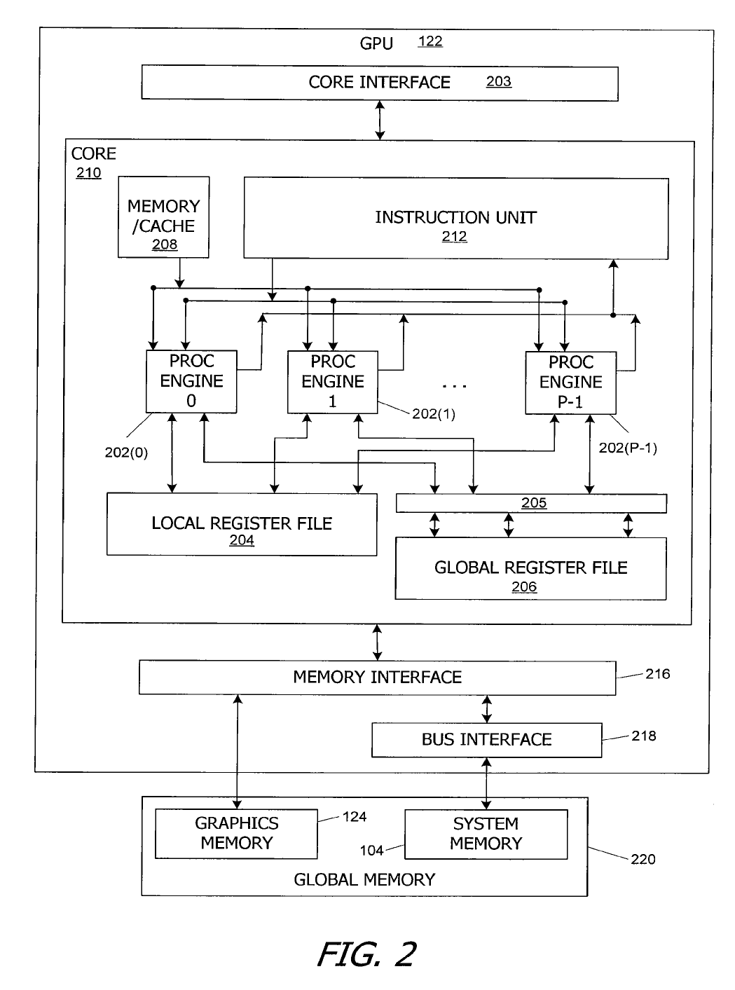

FIG. 2 is a block diagram of a GPU 112 usable in an embodiment of the present invention. GPU 122 includes a core 210 configured to execute a large number of threads in parallel, where the term “thread” refers to an instance of a particular program executing on a particular set of input data. In some embodiments, single instruction, multiple-data (SIMD) instruction issue techniques are used to support parallel execution of a large number of threads without providing multiple independent instruction fetch units.

In one embodiment, core 210 includes an array of P (e.g., 16) parallel processing engines 202 configured to receive SIMD instructions from a single instruction unit 212. Each processing engine 202 advantageously includes an identical set of functional units (e.g., arithmetic logic units, etc.). The functional units may be pipelined, allowing a new instruction to be issued before a previous instruction has finished, as is known in the art. Any combination of functional units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations.

Each processing engine 202 uses space in a local register file 204 for storing its local input data, intermediate results, and the like. In one embodiment, local register file 204 is physically or logically divided into P lanes, each having some number of entries (where each entry might be, e.g., a 32-bit word). One lane is assigned to each processing unit, and corresponding entries in different lanes can be populated with data for different threads executing the same program to facilitate SIMD execution. The number of entries in local register file 204 is advantageously large enough to support multiple concurrent threads per processing engine 202.

Each processing engine 202 also has access, via a crossbar switch 205, to a global register file 206 that is shared among all of the processing engines 202 in core 210. Global register file 206 may be as large as desired, and in some embodiments, any processing engine 202 can read to or write from any location in global register file 206. Global register file 206 advantageously provides a shared memory with low latency. In addition to global register file 206, some embodiments also provide additional on-chip shared memory and/or cache(s) 208, which may be implemented, e.g., as a conventional RAM or cache. On-chip memory 208 is advantageously used to hold data needed by multiple threads. Processing engines 202 also have access via a memory interface 216 to additional off-chip global memory 220, which includes, e.g., graphics memory 124 and/or system memory 104, with system memory 104 being accessible by memory interface 216 via a bus interface 218; it is to be understood that any memory external to GPU 112 may be used as global memory 220. Memory interface 216 and bus interface 218 may be of generally conventional design, and other appropriate interfaces may be substituted. Processing engines 202 are advantageously coupled to memory interface 216 via an interconnect (not explicitly shown) that allows any processing engine 202 to access global memory 220.

In one embodiment, each processing engine 202 is multithreaded and can execute up to some number G (e.g., 24) of threads concurrently, e.g., by maintaining current state information associated with each thread in a different portion of its assigned lane in local register file 204. Processing engines 202 are advantageously designed to switch rapidly from one thread to another so that instructions from different threads can be issued in any sequence without loss of efficiency.

Instruction unit 212 is configured such that, for any given processing cycle, the same instruction is issued to all P processing engines 202. Thus, at the level of a single clock cycle, core 210 implements P-way SIMD microarchitecture. Since each processing engine 202 is also multithreaded, supporting up to G threads, core 210 in this embodiment can have up to P*G threads executing concurrently. For instance, if P=16 and G=24, then core 210 supports up to 384 concurrent threads.

Because instruction unit 212 issues the same instruction to all P processing engines 202 in parallel, core 210 is advantageously used to process threads in “SIMD groups.” As used herein, a “SIMD group” refers to a group of up to P threads of execution of the same program on different input data, with one thread of the group being assigned to each processing engine 202. (A SIMD group may include fewer than P threads, in which case some of processing engines 202 will be idle during cycles when that SIMD group is being processed.) Since each processing engine 202 can support up to G threads, it follows that up to G SIMD groups can be executing in core 210 at any given time.

On each clock cycle, one instruction is issued to all P threads making up a selected one of the G SIMD groups. To indicate which thread is currently active, a “group index” (GID) for the associated thread group may be included with the instruction. Processing engine 202 uses group index GID as a context identifier, e.g., to determine which portion of its allocated lane in local register file 204 should be used when executing the instruction. Thus, in a given cycle, all processing engines 202 in core 210 are nominally executing the same instruction for different threads in the same group. (In some instances, some threads in a group may be temporarily idle, e.g., due to conditional or predicated instructions, divergence at branches in the program, or the like.)

It will be appreciated that the core architecture described herein is illustrative and that variations and modifications are possible. Any number of processing engines may be included. In some embodiments, each processing engine has its own local register file, and the allocation of local register file entries per thread can be fixed or configurable as desired. Further, while only one core 210 is shown, a GPU 122 may include any number of cores 210, with appropriate work distribution logic to distribute incoming processing tasks among the available cores 210, further increasing the processing capacity.

### Cooperative Thread Arrays (CTAs)

In accordance with an embodiment of the present invention, multithreaded processing core 210 of FIG. 2 can execute general-purpose computations using cooperative thread arrays (CTAs). As used herein, a “CTA” is a group of multiple threads that concurrently execute the same program on an input data set to produce an output data set. Each thread in the CTA is assigned a unique thread identifier (“thread ID”) that is accessible to the thread during its execution. The thread ID controls various aspects of the thread's processing behavior. For instance, a thread ID may be used to determine which portion of the input data set a thread is to process, to identify one or more other threads with which a given thread is to share an intermediate result, and/or to determine which portion of an output data set a thread is to produce or write.

CTAs are advantageously employed to perform computations that lend themselves to a data parallel decomposition, i.e., application of the same processing algorithm to different portions of an input data set in order to effect a transformation of the input data set to an output data set. The processing algorithm is specified in a “CTA program,” and each thread in a CTA executes the same CTA program on a different subset of an input data set. A CTA program can implement algorithms using a wide range of mathematical and logical operations, and the program can include conditional or branching execution paths and direct and/or indirect memory access.

Threads in a CTA can share intermediate results with other threads in the same CTA using a shared memory (e.g., global register file 206) that is accessible to all of the threads, an interconnection network, or other technologies for inter-thread communication, including technologies known in the art. In some embodiments, a CTA program includes an instruction to compute an address in shared memory to which particular data is to be written, with the address being a function of thread ID. Each thread computes the function using its own thread ID and writes to the corresponding location. The address function is advantageously defined such that different threads write to different locations; as long as the function is deterministic, the location written to by any thread is well-defined. The CTA program can also include an instruction to compute an address in shared memory from which data is to be read, with the address being a function of thread ID. By defining suitable functions and providing synchronization techniques, data can be written to a given location by one thread and read from that location by a different thread in a predicable manner. Consequently, any desired pattern of data sharing among threads can be supported, and any thread in a CTA can share data with any other thread in the same CTA.

Since all threads in a CTA execute the same program, any thread can be assigned any thread ID, as long as each valid thread ID is assigned to only one thread. In one embodiment, thread IDs are assigned sequentially to threads as they are launched. It should be noted that as long as data sharing is controlled by reference to thread IDs, the particular assignment of threads to processing engines will not effect the result of the CTA execution. Thus, a CTA program can be independent of the particular hardware on which it is to be executed.

Any unique identifier (including but not limited to numeric identifiers) can be used as a thread ID. In one embodiment, if a CTA includes some number (T) of threads, thread IDs are simply sequential (one-dimensional) index values from 0 to T−1. In other embodiments, multidimensional indexing schemes may be used.

In addition to thread IDs, some embodiments also provide a CTA identifier that is common to all threads in the CTA. CTA identifiers can be helpful, e.g., where an input data set is to be processed using multiple CTAs that process different (possibly overlapping) portions of an input data set. The CTA identifier may be stored in a local register of each thread, in a state register accessible to all threads of the CTA, or in other storage accessible to the threads of the CTA.

While all threads within a CTA are executed concurrently, there is no requirement that different CTAs are executed concurrently, and the hardware need not support sharing of data between threads in different CTAs.

It will be appreciated that the size (number of threads) of a CTA and number of CTAs required for a particular application will depend on the application. Thus, the size of the CTA, as well as the number of CTA to be executed, are advantageously defined by a programmer or driver program and provided to core 210 and core interface 203 as state parameters.

### C/C++ Language Extension for General-Purpose GPU

A general-purpose programming environment allows users to program a GPU as a general-purpose computation engine using C/C++ programming constructs. A path is provided for users familiar with C/C++ programming to write programs which are accelerated by the GPU. The path is achieved by providing extensions to the conventional C/C++ programming languages to support general-purpose GPU computation. Parts of the code in a source file are specified to be compiled for the CPU and/or for the GPU. Specifically, functions, objects and variables may be specified for CPU and/or GPU binary compilation using declaration specifiers. The location of objects and variables in different memory locations in the system may be identified using declaration specifiers. CTA threading information is also provided for the GPU in the language extensions.

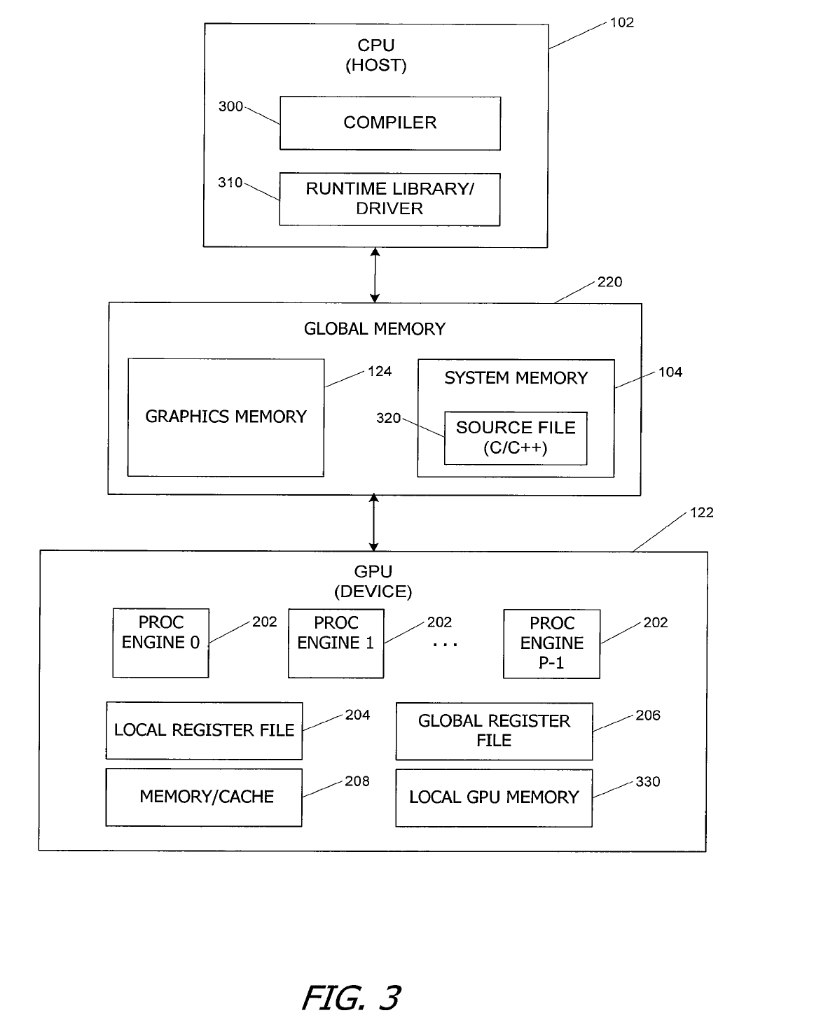

FIG. 3 is a block diagram of a GPU and a CPU usable in an embodiment of the present invention. CPU 102 includes a compiler 300 and a runtime library/driver 310. As discussed above with reference to FIG. 2, GPU 122 includes processing engines 202 and different types of memory for storing data that is processed and/or shared by processing engines 202 operating in parallel. The different types of memory include local register file 204, global register file 206 and memory/cache 208. GPU 122 may also include GPU memory 330 which is local memory that is not used to store data associated with CTAs executing on processing engines 202. Global memory 220 includes graphics memory 124 and system memory 104. Source file 320 is stored in system memory 104.

Source file 320 is a C/C++ language file that is generated by a programmer and includes a number of functions, objects and variables. Compiler 300 converts source file 320 to an equivalent computer-executable form for execution on CPU 102 and/or GPU 122. In one embodiment, source file 320 consists of only CPU-executable code, in which case compiler 300 processes source file 320 as a conventional CPU compiler. In another embodiment, the programmer may apply GPU-specific declaration specifiers to a function such that the function is compiled for execution on GPU 122 (i.e., the function is converted into GPU-executable binary code). For example, the programmer may indicate that the function is to be executed on GPU 122 by providing a declaration specifier before the name of the function in source file 320. The programmer may provide declaration specifiers with every function in source file 320 such that each function is compiled for execution on GPU 122.

In one embodiment, source file 320 includes functions, memory objects, and variables to be compiled for both CPU 102 and GPU 122. Conventional GPU programming solutions required that the GPU code be compiled in a separate source file. The language extensions of the present invention permit GPU code and CPU code to be included in the same source file since each function or memory object can be explicitly targeted to either (or both) platforms. Compiler 300 separates the GPU binary code and the CPU binary code using the language extensions to split the code compilation into the respective GPU and CPU platforms. Compiler 300 is similar to a conventional CPU-targeting compiler with the exception that it supports the language extensions described below and is responsible for converting the <<<n, m>>> language extension described below, into runtime calls. Compiler 300 is also responsible for generating code that uses runtime library 310 to perform typical initializations of and on the device.

Runtime library/driver 310 provides compiler 300 with support routines for implementing the new C/C++ language constructs according to the present invention. Runtime library/driver 310 also provides routines for use by the programmer for basic execution and data management for GPU 122. Example routines include allocating and de-allocating memory, copying routines for fast transfer of data to and from GPU 122, and error detection. These runtime routines are similar to the C/C++ runtime functions familiar to CPU programmers.

The language extensions according to the present invention advantageously allow users to specify which portions of a program are to be compiled for CPU 102 or GPU 122. The language extensions may also establish whether objects/variables are resident in memory associated with CPU 102 or GPU 122. The programming model in accordance with the present invention is explicit such that users have full knowledge of and control over whether a function is executed on or an object resides on CPU 102 or GPU 122.

As discussed above with reference to FIG. 2, functions to be executed on GPU 122 may execute as parallel function calls when GPU 122 is configured as a threaded processor with processing engines 202 operating in parallel. Before CPU 102 launches a function in source file 320 for execution on GPU 122, the function requires information about the number of threads and the number of CTAs in order to keep track of the different threads executing in parallel. CPU 102 provides this information to GPU 122 when a function is called using the following language extension for a particular function call:

<<<n, m>>>

where n is the number of CTAs and m is the number of threads per CTA. Values for n and m may be scalar integers or built-in vectors. The “<<< >>>” syntax was selected because previously this syntax did not have meaning in the C/C++ programming language. This language extension is provided between a function name and arguments/parameters of the function to provide metadata so that compiler 300 can parse the syntax for the particular block and thread that is executing the function. For example, a function (f) having parameters (a) is called using the following syntax:

f<<<n, m>>>(a)

Thus, n x m copies of the function are executed on processing engines 202 of GPU 122.

To specify that a function is to be compiled for GPU 122, two function declaration specifiers are provided—a “global” function declaration specifier and a “device” function declaration specifier. When the global function declaration specifier is applied to a function in source file 320, compiler 300 translates the function source code for execution on GPU 122, but the function is callable only from CPU 102. The global function declaration specifiers is applied to a function (f) as follows:

_global_void f(int a)

When the device function declaration specifier is applied to a function, compiler 310 compiles the function code for execution on GPU 122, but the function is only callable from another GPU function. The device function declaration specifier is applied to a function (g) as follows:

_device_int g(int a)

Built-in variables are provided in device-qualified functions that identify threading information for each thread executing on GPU 122. Each variable includes a grid dimension, where the grid includes all of the CTAs that are executing in GPU 122. Each variable also includes the specific CTA number within the grid, the CTA dimensions, and the specific thread number within the CTA.

A “host” function declaration specifier specifies that function code is compiled for execution on CPU 102. In one embodiment, compiling source code for execution on CPU 102 is the default for all functions. The host function declaration specifier is useful when applying multiple function declaration specifiers to specify whether the function should be compiled for both CPU 102 and GPU 122. For example,

_host_{——}device_int max(int a, int b)

The function (max) is callable both from CPU code and GPU code such that the source code is compiled twice—once for CPU 102 and once for GPU 122. Multiple function qualifiers are useful for establishing utility functions for use on both CPU and GPU platforms.

Memory object declaration specifiers are provided to identify the location of objects and variables in memory. Example memory object declaration specifiers include “global”, “device”, “shared”, “local”, or “constant”. Objects declared with either a global or a device declaration specifier are directly addressable by GPU code. The global memory object declaration specifier indicates that the object/variable resides in GPU memory 330 and is directly addressable by CPU 102. Thus, the object/variable can be accessed by GPU 122 or CPU 102. The global memory object declaration specifier is applied to an object/variable (“a”) as follows: _global_int a. The device memory object declaration specifier indicates that the object/variable resides in GPU memory 330 but is not directly addressable by CPU 102. The device memory object declaration specifier is applied to an object/variable (“a”) as follows: _device_int a. “Global” memory objects are considered more “expensive” than “device” memory objects since these memory objects consume CPU address space.

The shared memory object declaration specifier specifies memory, such as global register file 206, which is shared across the threads in a CTA in GPU 122. The shared memory object declaration specifier is applied to an object/variable (“x”) as follows: _shared_int x. The shared memory object declaration specifier is allocated at the creation of a CTA and reclaimed at the completion of the last thread of the CTA. Each CTA is provided a separate instance of the shared objects/variables, and different CTAs cannot access the shared memory of other blocks.

The local memory object declaration specifier specifies per thread memory, such as local register file 204, for objects/variables residing on GPU 122. The local memory object declaration specifier is applied to an object/variable (“p”) as follows: _local_int p. The local object/variable is instantiated at thread creation and is reclaimed at thread completion.

The constant memory object declaration specifier specifies that the object/variable resides in GPU read-only memory (e.g., memory/cache 208). This separate memory space is optimized for read-only memory such that the object/variable may be accessed quickly. The constant memory object declaration specifier is applied to an object/variable (“a”) as follows: _constant_int a.

Each of the declaration specifiers is implemented with a Microsoft Visual C declaration specification or a GNU Compiler Collection (GCC) attribute such that the built-in compiler mechanism extends the C/C++ programming language. For example, the local memory object declaration specifier is implemented as a macro for the code “_declspec(_local_)” which is understood by compiler 300 for Windows platforms. The GCC attribute mechanism “_attribute_((_local_))” is used on Linux platforms.

Pointers to memory are used in the same way as in conventional C/C++ programming. The pointers identify memory associated with either CPU 102 (e.g., system memory 104) or GPU 122 (e.g., GPU memory 330). A user may use the address of a global or device memory object from GPU code. Multiple pointer types may be supported to allow pointers to shared, constant, and local memory objects. These other GPU memory spaces could all reside in one global address space (e.g. local memory resides at address 0x1000 to 0x2000, constant memory at 0x2000 to 0x3000, etc.). Alternatively, explicit type information may be placed on the pointers. For example, the following syntax provides a pointer to a shared memory object of type int:

_shared_int*a

The present invention provides a C/C++ general-purpose GPU programming model that is similar to a conventional CPU programming model. Unlike applications which use other graphics programming languages, generic C/C++ code is identified for execution on GPU 122 without the programmer requiring any specific graphics knowledge. Code is executed on GPU 122 merely by calling a function that has been specified for GPU execution by the programmer.

The present invention relates to using the GPU as a general-purpose computation engine rather than conventional programmable shading. However, the invention does not preclude the use of the GPU for conventional graphics purposes, such as image generation, geometry processing, or pixel/vertex processing.

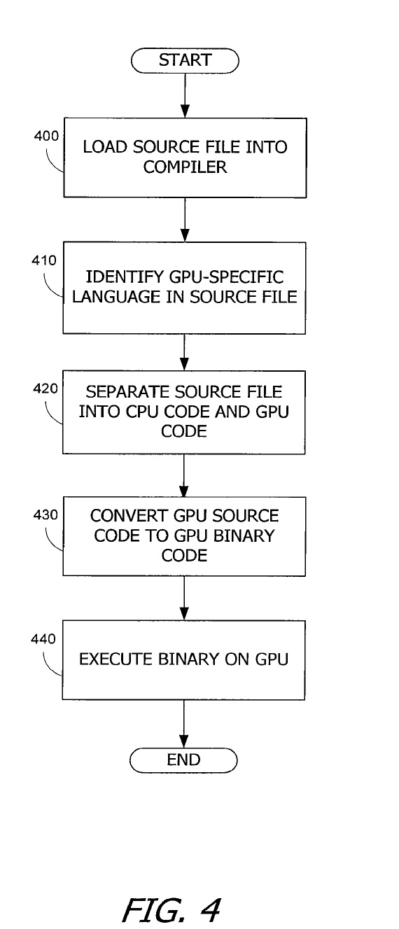

FIG. 4 is a flowchart illustrating a process for compiling a source file that includes C/C++ language extensions for general-purpose GPU programming according to the present invention.

At operation 400, a source file is loaded into a compiler. The source file is written using the C/C++ programming language. A programmer can generate the source file and identify which portions of the program are to be executed by CPU 102 or GPU 122 (or both). In one embodiment, the CPU executes the code unless the programmer explicitly declares the portions of the code are to be executed by the GPU. For example, the programmer may place a declaration specifier in front of a function name such that the function will be executed on the GPU.

At operation 410, GPU-specific language is identified in the source file. The GPU-specific language may include keywords, language extensions and threading information to support general-purpose GPU computation. As discussed above, a function may be identified to execute on GPU 122 by applying GPU-specific declaration specifiers (e.g., “global” or “device”). Memory object declaration specifiers (e.g., “global”, “device”, “shared”, “local” or “constant”) are also included as GPU-specific language to identify locations in GPU memory where objects/variables are stored.

At operation 420, the compiler parses source file 320 and separates the code into CPU code and GPU code based on the GPU-specific language. Any code in source file 320 that is defined with declaration specifiers for GPU execution (e.g., function declaration specifiers or memory object declaration specifiers) are separated from conventional CPU-executable source code. Operation 420 also generates code for the language extension for threading information (i.e., <<<n, m>>>) using runtime library 310. Code is also generated for performing typical initializations of and on the device.

At operation 430, the GPU code is compiled and converted into GPU-specific binary code. Runtime library/driver 310 provides compiler 300 with support routines for translating the GPU-specific code into GPU executable binary code. The resulting binary GPU code is then embedded in the host code, which is to be compiled with a host compiler. The application is then executed on the CPU 122 at operation 440.

It will be appreciated that the process shown in FIG. 4 is illustrative and that variations and modifications are possible. Steps described as sequential may be executed in parallel, order of steps may be varied, and steps may be modified or combined.

While the invention has been described with respect to specific embodiments, one skilled in the art will recognize that numerous modifications are possible. The scope of the invention should, therefore, be determined with reference to the appended claims along with their full scope of equivalents.

What is claimed is:

1. A method for compiling a source file, the method comprising:
loading a source file into a compiler, the source file comprising code associated with execution of functions on a graphics processing unit (GPU) and code associated with execution of functions on a central processing unit (CPU);
identifying GPU programming language in the source file that indicates that code associated with the GPU programming language is to be executed on the GPU;
separating the code associated with the GPU programming language from the source file; and
converting the code associated with the GPU programming language into binary code for execution on the GPU.

2. The method of claim 1 wherein identifying the GPU programming language in the source file further comprises identifying a declaration specifier in the source file, wherein the declaration specifier indicates that a function is to be executed on the GPU.

3. The method of claim 1 wherein the GPU programming language comprises threading information associated with a function to be executed on the GPU, the threading information being provided to the GPU such that the GPU executes the function in parallel using the threading information.

4. The method of claim 3 wherein the threading information includes the number of thread arrays executing in the GPU and the number of threads in each thread array.

5. The method of claim 1 wherein the GPU programming language comprises a global function declaration specifier associated with a function, the global function declaration specifier identifying the function as being called by the CPU for execution on the GPU.

6. The method of claim 1 wherein the GPU programming language comprises a device function declaration specifier associated with a function, the device function declaration specifier identifying the function as being called by another GPU for execution on the GPU.

7. The method of claim 1 wherein the GPU programming language comprises multiple function declaration specifiers associated with a function, the multiple function declaration specifiers identifying the function as being compiled for execution on the CPU and the GPU.

8. The method of claim 1 wherein the GPU programming language comprises a global declaration specifier associated with a memory object, the global declaration specifier identifying the memory object as being stored in memory associated with the GPU and addressable by the CPU.

9. The method of claim 1 wherein the GPU programming language comprises a device declaration specifier associated with a memory object, the device declaration specifier identifying the memory object as being stored in memory associated with the GPU and not addressable by the CPU.

10. The method of claim 1 wherein the GPU programming language comprises a shared declaration specifier associated with a memory object, the shared declaration specifier identifying the memory object as being stored in memory that is shared across threads in a thread array.

11. The method of claim 1 wherein the GPU programming language comprises a local declaration specifier associated with a memory object, the local declaration specifier identifying the memory object as being stored in local memory associated with individual threads in a thread array.

12. The method of claim 1 wherein the GPU programming language comprises a constant declaration specifier associated with a memory object, the constant declaration specifier identifying the memory object as being stored in read-only memory of the GPU.

13. The method of claim 1 wherein the source file further comprises a pointer to memory associated with the GPU.

14. A system for compiling a source file comprising:
a global memory configured to store a source file, the source file including code associated with execution of functions on a GPU and code associated with execution of functions on a CPU;
the CPU configured to:
load the source file from the global memory,
identify GPU programming language in the source file that indicates that code associated with the GPU programming language is to be executed on the GPU,
separate the code associated with the GPU programming language from the source file, and
convert the code associated with the GPU programming language into binary code for execution on the GPU; and
the GPU comprising:
memory for storing the binary code, and
at least one processing engine configured to execute the binary code.

15. The system of claim 14 wherein the GPU further comprises a plurality of processing engines for executing a function in parallel, wherein the GPU programming language comprises threading information associated with the function, the threading information being provided to the GPU such that the plurality of processing engines execute the function in parallel using the threading information.

16. The system of claim 15 wherein the threading information includes the number of thread arrays executing in the plurality of parallel processors of the GPU and the number of threads in each thread array.

17. The system of claim 14 wherein the GPU programming language comprises a global function declaration specifier associated with a function, the global function declaration specifier identifying the function as being called by the CPU for execution on the GPU.

18. The system of claim 14 wherein the GPU programming language comprises a device function declaration specifier associated with a function, the device function declaration specifier identifying the function as being called by another GPU for execution on the GPU.

19. The system of claim 14 wherein the GPU programming language comprises a global declaration specifier associated with a memory object, the global declaration specifier identifying the memory object as being stored in the memory for storing the binary code and addressable by a CPU.

20. The system of claim 14 wherein the GPU programming language comprises a device declaration specifier associated with a memory object, the device declaration specifier identifying the memory object as being stored in the memory for storing the binary code and not addressable by a CPU.
